(19) United States
(12) Patent Application Publication
(10) Pub. No.: US 2002/0026328 A1
(43) Pub. Date: Feb. 28, 2002

(54) Method and system for management of patient accounts

(76) Inventors: Thomas M. Westerkamp, Houma, LA (US); John J. Westerkamp, Beavercreek, OH (US)

Correspondence Address: BIEBEL & FRENCH, 35 EAST FIRST STREET, DAYTON, OH, 45402

(21) Appl. No.: 09/849,064

(22) Filed: May 4, 2001

Related U.S. Application Data
(60) Provisional application No. 60/202,240, filed on May 5, 2000.

(51) Int. Cl. G06F 17/60

(52) U.S. Cl. 705/2

(57) ABSTRACT

A method and apparatus for remote management of patient accounts for the healthcare industry comprising key flashpoints in the patient account lifecycle and a centralized management unit that oversees and manages the entire patient account lifecycle. The centralized management unit comprises a manager and a plurality of management control reports, alerts, edits, and checklists. The manager communicates with the healthcare provider, patients, and payors to obtain information required to ensure maximum reimbursement of claims for healthcare services. Operating reports are included whereby healthcare providers can monitor the performance of the system and continuously improve the process resulting in improved cash flow, reduced bad debt, reduced costs, and reduced healthcare days in receivable. Standards are defined for each of the performance measures. An apparatus for remote management of patient accounts using this method is described comprising an encrypted communication network with user authentication to protect patient privacy and the security of the healthcare service provider's data and network whereby the centralized management unit can use the existing healthcare service provider's patient accounts system or whereby the healthcare provider can outsource any portion or all of the patient accounts system for management by the centralized management unit without having to maintain two sets of patient accounts.

### BACKGROUND OF THE INVENTION 1. Field of the Invention

The present invention relates to the management and reconciliation of patient accounts for the healthcare industry, and more specifically, to a method and computer implementation for remote management of the entire patient account lifecycle whereby healthcare providers can realize maximum revenues for services billed.

2. Description of the Prior Art

The patient account lifecycle spans the time when a patient first arranges for healthcare services until the time when the patient's account has been brought to zero balance. The healthcare industry, however, provides an environment in which extreme differences exist between what is charged for services rendered and what is ultimately received in cash. An excellent healthcare operation may be optimal in receiving 60% in cash for charges/revenue incurred. Further, a poor operation with the exact same patient mix and charges may receive only 40% in cash for charges/revenue incurred. This discrepancy can amount to over $10,000,000.00 a year to a healthcare service provider. Healthcare is arguably the most inefficient industry in the country.

The healthcare industry has continued to grow nationally and in virtually every market. Over the past several years there have been several large shifts that have provided business office operations with significant challenges. The main operational impact areas have been the shift to out-patient services, the increase in managed care, increased bureaucracy, the lack of integrated automated systems to confront the challenges and a poor quality labor pool.

Across the country there is a shift to out-patient services. Additionally, there has been pressure from Medicare, Managed Care Companies and technology to reduce the length of stay for in-patient accounts. The business office must now have a higher volume of in-patient accounts to maintain a census similar to the prior years because the length of stay is shorter. Additionally, the business office has to confront the high volume of out-patient surgeries (many previously done as in-patient), emergency room volume, and out-patient ancillaries.

Managed Care Companies, including HMO'S, PPO's and silent PPO's all have placed administrative burdens on the business office. They require additional paperwork such as referrals, authorizations, and pre-certifications while paying only a fraction of the total charge. Also, these companies attempt to delay the payment process and require heightened volume of business office activity to effect payment.

The foregoing factors have caused an extreme shift in the business office. The new business office equation includes more accounts, requiring a higher level of analysis with lower per account net reimbursement. Patient Account Representatives have to possess a higher level of knowledge and exceptional analytical abilities. Each account regardless of size requires analysis and action to bring the account to a zero balance. There are several potential negative ramifications if accounts are not properly reconciled which include:

Incorrect contractuals thereby creating additional work (cost) or lost reimbursement (cash),

Inappropriate billing to patients,

High volume of unprocessed claims,

Inappropriate workers compensation billing,

Erroneous billing of Medicaid,

Erroneous billing of Medicare and the related compliance problems,

Breach of contract with managed care payors, and

Most importantly, public relations problems rooted in the patient base.

Healthcare staffing levels and procedures need review to ensure that an appropriate level of attention is given to each patient account. In most healthcare service providers accounts receivable, an inverse relationship of volume versus dollars exists. Often times 80% of the accounts receivable dollars are represented by 20% of the volume. A review of total A/R in descending order will identify this situation. However, this 80% of patient accounts represents significant dollars to the healthcare service provider and significant potential downside in terms of liability if not properly administered.

To combat these problems, healthcare service providers now rely on commercial computer software systems that perform complete contractual aging of patient accounts. Often, several different software systems are used for different portions of the patient account lifecycle. There is a great deal of emphasis on information entry and retrieval, but little emphasis on information transfer throughout the patient account lifecycle or processing of the information to maximize revenues. Even in comprehensive software systems, complete contractual aging is almost impossible to implement since contractual agreements vary a great deal and must be flexible. Healthcare service providers have contractual agreements with Medicare, Medicaid, and Managed Care companies, among others. These agreements require the healthcare service provider to accept limited payments and absorb or write-off the difference. The difference is called a contractual adjustment. Many existing systems bill the payor for charges either electronically or with a hard-copy bill. After the healthcare service provider receives payment, the business office manually computes, writes-up, and processes a contractual adjustment. The process that accomplishes this task is generally known as “modeling”. Modeling profiles each payor's contract and, when a patient is processed under that payor, the appropriate contractual adjustment is computed and applied to the account. Most of the existing modeling systems are inflexible in dealing with the increasing volume of carve-outs or exceptions to the general rule. For example, a Managed Care contract might call for a $1,000.00 per day per diem. However, if charges exceed $50,000.00, then the healthcare service provider is paid 65% of charges. Current systems may only calculate the per diem and therefore provide an incorrect contractual since they are not flexible enough to handle the additional constraint. The result is that even healthcare providers with modern computer equipment and integrated accounting and patient management systems are still unable to realize large portions of their potential revenues.

Various inventors have attempted to computerize portions of the patient account lifecycle. For instance, there are several examples of prior art addressing the verification of patient insurability including U.S. Pat. Nos. 4,491,725 to Pritchard (1985) and 5,832,447 to Rieker et al. (1998). These inventions help to reduce errors in the billing process by providing real-time verification of patient health insurance eligibility. They are focused, however, only on this small portion of the patient account lifecycle and only respond with data in an existing database. They do not provide any management process for the patient account lifecycle and are only reactive to a direct query.

A second area of prior art addresses the billing process itself as described in U.S. Pat. Nos. 5,930,759 to Moore et al. (1999) and 5,956,690 to Haggerson et al. (1999). The first invention describes a method for processing healthcare electronic data claims and is intended for use by the payor or a healthcare clearinghouse and not the healthcare provider. It is focused solely on processing billing claims and provides no management solution for other portions of the patient account lifecycle. The second invention describes a bundled billing method that sorts through patient accounts and produces a set of aggregated bills to send to a payor. It is intended for use by the healthcare provider, but is focused only on the billing portion of the patient account lifecycle.

The third area of prior art is intended for use by self-insurers as described in U.S. Pat. No. 5,235,507 to Sackler et al. (1998). This invention is a system for monitoring a large number of insurance policies for a self-insurer with many employees. The system performs insurance eligibility verification and calculates how much of the claim should be paid to the healthcare provider. Again, it is focused on the billing process only and is used by the insurer not the healthcare provider.

It is clear from this discussion that all inventions known heretofore addressing the patient account lifecycle suffer from a number of disadvantages.

a) They are focused on only one portion of the patient account lifecycle. As such, they provide neither information about the interaction among the various parts of the patient account lifecycle nor any means for exploiting that information over time.

b) They are reactive systems in that they present only pre-existing information stored in a database. Since they do not process that information in any proactive way, there is no way of knowing whether the information is complete or accurate.

c) The systems that provide management reports, alerts, or specialized edits do not feed this information to other parts of the patient account lifecycle in any systematic way so the information is often lost or ignored until the billing phase. At this point, it is often too late to recover the required information and complete the billing. As a result, these bills are often simply ignored and eventually written-off as bad debt and sent to a collection agency.

d) They do not provide any management of the overall patient account lifecycle process in the form of checklists, alerts, edits, and control reports that can be integrated throughout the patient account lifecycle.

e) They do not provide any means for monitoring the patient account lifecycle and evaluating the performance of the management system. This makes it very difficult to discover which parts of the patient account lifecycle are being neglected and therefore almost impossible to improve the process and increase revenues.

As a result of these disadvantages, the healthcare industry provides an environment in which extreme differences exist between what is charged for services rendered and what is ultimately received in cash. Systematic communication of information to support and ensure collection of revenues billed simply does not exist. Clearly, there is a need for a business process that manages the entire patient account lifecycle rather than focusing on portions of the lifecycle.

### SUMMARY OF THE INVENTION

In accordance with a method for management of the patient account lifecycle comprises flashpoints and a centralized management unit, control reports, edits and alerts, and automated checklists and a means for integrating and communicating information over the entire patient account lifecycle as well as a means for computerized implementation comprising a communication network, encryption and authentication devices, a database management software system, and business office services provider workstations.

Other objects and advantages of the invention will be apparent from the following description, the accompanying drawings and the appended claims.

### BRIEF DESCRIPTION OF THE DRAWINGS

FIG. 1 is a depiction of the process flow for the present invention showing the key flashpoints within the patient account lifecycle and the centralized management unit.

FIG. 2 is a detailed description of the centralized management unit.

FIGS. 3a and 3b depict items associated with the Pre-Registration flashpoint.

FIGS. 4a and 4b depict items associated with the Admission/Registration flashpoint.

FIGS. 5a, 5b, and 5c depict items associated with the In-House flashpoint.

FIGS. 6a, 6b, and 6c depict items associated with the Discharge flashpoint.

FIGS. 7a and 7b depict items associated with the Suspense flashpoint.

FIG. 8 depicts items associated with the Billing flashpoint.

FIGS. 9a, 9b, 9c, and 9d depict items associated with the Follow-Up/Collections flashpoint.

FIGS. 10a and 10b depict an example of the Operating Report.

FIG 11a and 11b depict details of the Average Daily Revenue and Gross AIR Days computation in the Operating Report and a Standard for Comparison.

FIGS. 12a and 12b depict details of the remaining entries in the Operating Report and Standards for Comparison.

FIG. 13 depicts a means for remote management of the patient account lifecycle using a virtual private network via the Internet that is encrypted for privacy and employs digital certificates for user authentication.

FIG. 14 depicts an alternative means for remote management of the patient account lifecycle using a web-based application via Secure Sockets Layer (SSL) with encryption for privacy and digital certificates for user authentication.

### DETAILED DESCRIPTION OF THE PREFERRED EMBODIMENT

The patient account lifecycle management system of the present invention is essentially a communication system that efficiently manages information throughout the patient account lifecycle. The management system processes the information to maximize revenues received for services billed by anticipating billing requirements. Although the patient account lifecycle includes many steps, this invention comprises seven key flashpoints within the patient account lifecycle that are critical for managing the overall process. A flashpoint is a defined point in time in the patient account lifecycle with a specific purpose that provides an optimum opportunity for management of the patient account. These flashpoints represent times within the patient account lifecycle where management intervention is possible and will be most effective. As depicted in FIG. 1, the flashpoints are

1. Pre-registration 10—A contact point prior to the actual point of service.

2. Admission/Registration 12—The point at which a patient presents for service.

3. In-House 14—The time period from beginning of clinical service through patient's exiting the healthcare facility.

4. Discharge 16—The point at which the patient leaves the healthcare facility.

5. Suspense 18—The time period after discharge and before minimum billing point.

6. Billing 20—Point at which an electronic or hardcopy bill is sent to payor for adjudication.

7. Follow-Up/Collection 22—Post billing period of activity affecting the accounts.

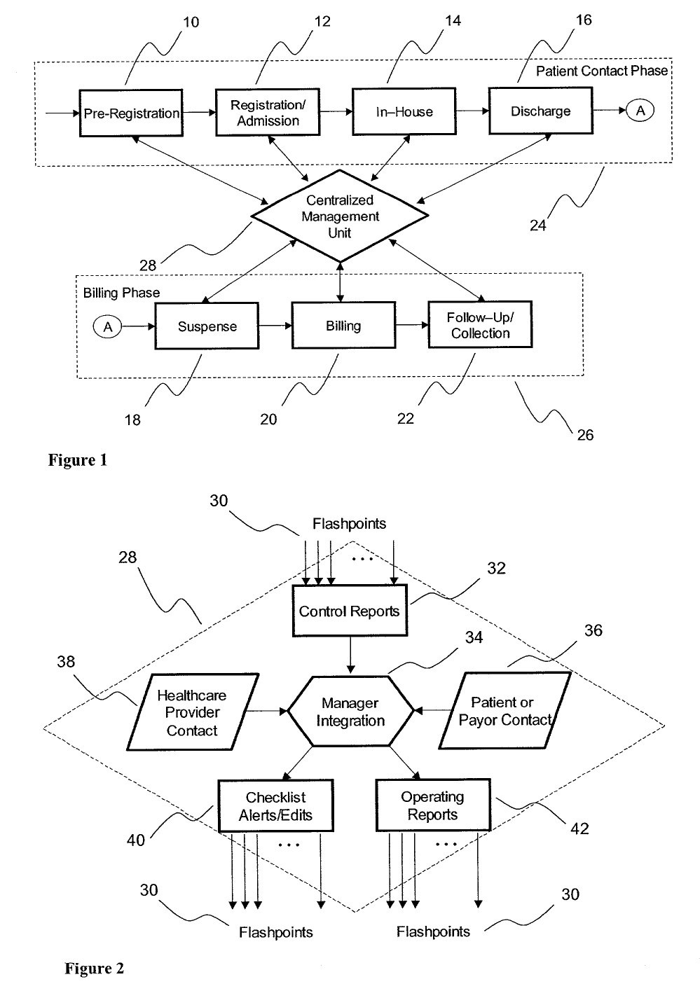

The flashpoints are grouped into two phases, a Patient Contact Phase 24 and a Billing Phase 26. All of the flashpoints communicate with a centralized management unit 28. The centralized management unit 28 is depicted in FIG. 2 and is where the business office services manager integrates information 34 from all portions of the patient account lifecycle and ensures that required information is collected at each flashpoint 30. The centralized management unit 28 anticipates billing requirements beyond those hard-coded into the contractual aging software and generates control reports 32, alerts, edits, and checklists 40 to ensure maximum revenues received for services billed. Control reports are management reports that are created by querying the patient account software system at some flashpoint. The control reports consist of information that can be compared with anticipated billing requirements. Edits are informational items entered into the patient account software system that are necessary for billing. Alerts are notices sent to the person entering the data into the patient account system to ensure that required information is collected from the patient. Checklists are a combination of edits and alerts that comprise all of the required information that must be entered during a given flashpoint to ensure maximum revenue for the service billed. To process the information, the manager may have to contact the healthcare provider 38 or the patient/payor 36 to obtain required information to complete the edits and ensure successful billing. The centralized management unit 28 also provides a means for continuous improvement of the patient account lifecycle process through operating reports 42. These reports provide direct insight into the patient account lifecycle and allow the business office services provider to monitor, direct, and train the healthcare service provider's staff and ensure that problem areas are corrected quickly and bad debt write-offs are avoided.

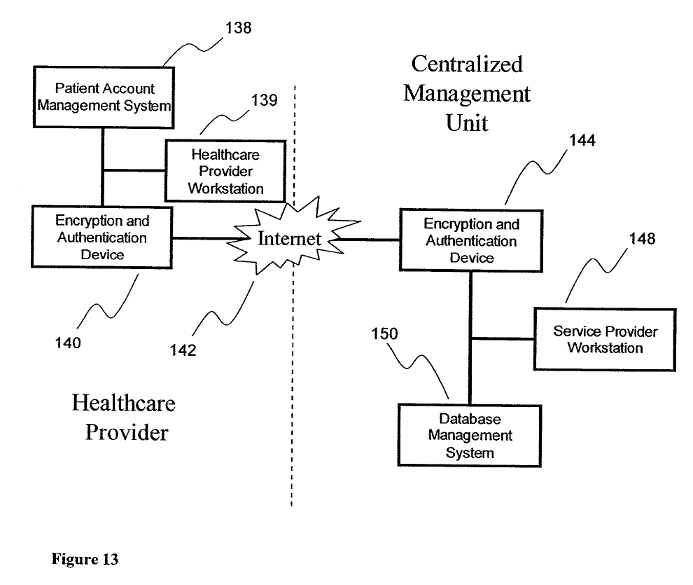

A means for remotely managing patient accounts using this system is depicted in FIG. 13. This is an off-site approach using a virtual private network (VPN) to access the existing healthcare provider's software and remotely manage any portion of the patient account lifecycle. At the healthcare provider's location, the VPN comprises a patient account system 138 and an encryption and authentication device 140. At the centralized management unit location, the VPN comprises an encryption and authentication device 144, a database management software system 150, and computer workstations 148 equipped with terminal emulation software for communicating with the patient account system at the healthcare provider location. The Internet 142 is used as the communication medium. It is assumed that the healthcare provider location and the centralized management unit location have a local area network and the necessary equipment (e.g. routers and firewalls) for accessing the Internet.

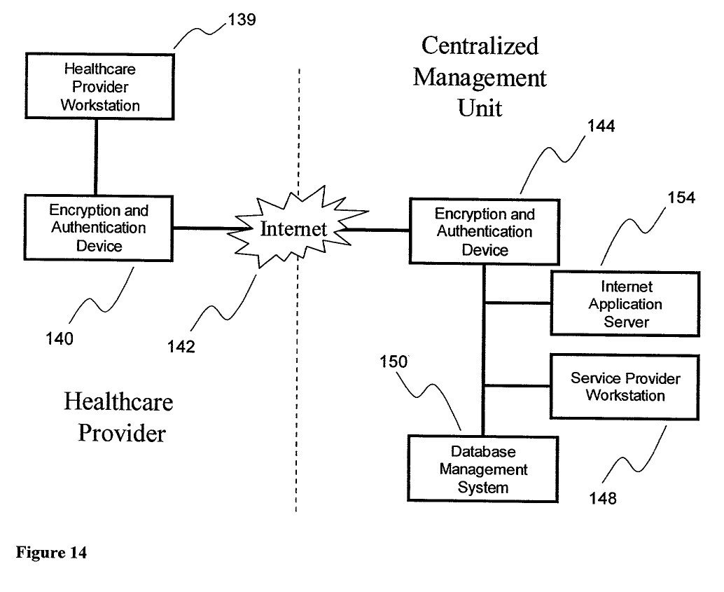

An alternative embodiment is depicted in FIG. 14. This is another off-site approach but provides for complete outsourcing of the entire patient accounts receivable or any portion thereof. In this embodiment, the healthcare provider uses workstation 139 to access a web-based application at the centralized management unit via the Internet 142. In this embodiment, the encryption and authentication devices 140, 144 comprise a Secure Sockets Layer (SSL) transaction with the application server 154 at the centralized management unit location. At the centralized management unit location, the encryption and authentication device 144 can further comprise an SSL accelerator and a means for authenticating users with digital certificates. The application server 154 at the centralized management unit 28 location implements the present invention in a database management system 150 (such as Oracle) and provides the application interface via a web-based application 154 (such as Java server pages). This embodiment is completely automated and independent of the healthcare provider's existing software. In fact, the healthcare provider need not use any patient account management software and can rely solely on the centralized management unit's web-based management software 154. Another web-based application and user interface is presented to the patient account lifecycle manager 34. This interface allows the service provider to work the patient accounts using the database management system 150 located at the centralized management unit 28 location.

From the description above, a number of advantages of the invention become clear:

a) The flashpoints provide a means for managing the entire patient account lifecycle using control reports and alerts to provide information about the interaction among the various parts of the patient account lifecycle. The availability of the information and the production of automated checklists allow the information to be exploited throughout the patient account lifecycle and not during only a single part;

b) The management control reports, alerts, and automated checklists provide a means for proactive management of the patient account and ensure that required information is complete and accurate;

c) The availability of the management control reports, alerts, and automated checklists throughout the patient account lifecycle allows them to be used at any time from any flashpoint;

d) The management control reports and operating reports allow for continuous improvement of the patient account lifecycle process. Improving the process at key flashpoints designated in the reports ensures that revenues will be maximized by improving cash flow, reducing bad debt, reducing costs, and reducing healthcare days in receivable;

e) The invention provides a means to manage the existing patient accounts system and can be used to manage any portion of the patient account lifecycle. This flexibility is very convenient for the healthcare provider and obviates the need to invest in new computer hardware or software;

f) The invention provides for patient privacy and for the security of the healthcare provider's data and network by using an encrypted VPN tunnel over the public Internet and digital certificates for user authentication. Remote access to the healthcare provider's existing network obviates the need to maintain duplicate sets of patient accounts and allows for centralized and coordinated management of multiple healthcare provider locations.

Further advantages are:

g) the system provided by the present invention is extremely flexible in its implementation so that healthcare service providers can request management of the process at any point in the patient account life cycle;

h) the system provided by the present invention is independent of the existing software used by the healthcare provider for receivables of patient accounts. Therefore it does not require the healthcare provider to make any costly software changes or upgrades;

i) the system provided by the present invention defines a set of key flashpoints to focus the patient count lifecycle management process;

j) the system provided by the present invention includes automated management triggers to ensure efficient control over the patient account lifecycle;

k) the system provided by the current invention includes key control reports that direct management intervention in the patient account lifecycle;

l) the system provided by the present invention generates periodic operating reports to enable management to track the patient account lifecycle and audit the improvements in cash flow, bad debt reduction, reduced costs, and reduced healthcare days in receivable;

m) the system provided by the present invention generates a management report with variances to original payor denials;

n) the system provided by the present invention eliminates the need for additional terminals dedicated to the business office service provider;

o) the system provided by the present invention saves personnel resources, time, and money for the healthcare provider;

p) the system provided by the present invention maintains patient privacy;

q) the system provided by the present invention is secure and protects the healthcare provider's network and data;

r) the system provided by the present invention can be implemented in various ways including on-site or remotely using the existing healthcare provider's software.

Operation

A typical healthcare provider has an existing patient account software system 138 (FIG. 13). Data entry staff members employed by the healthcare provider access the patient account software system 138 through computer workstations 139. The healthcare provider staff members collect billing and healthcare services information from the patient during the patient contact phase 24 (FIG. 1) and prepare billing claims during the billing phase 26. Communication between the manager 34 and the healthcare provider's data entry staff members who are responsible for the flashpoints 30 is typically done through the patient account software (either the existing patient account software using a Notes section or the web-based application provided by the centralized management unit, depending on the embodiment), however, it can also be accomplished with written memos or oral communication. Often, a different data entry staff member is responsible for each flashpoint in the patient account lifecycle. This emphasizes the need for centralized management since important information is likely to be lost as more people handle it.

The manager 34 in the centralized management unit 28 aggressively monitors and acts upon the information available from the flashpoints producing the most efficient patient account management resulting in maximum revenues for services billed. At any time in the patient account lifecycle, the patient account manager 34 in the centralized management unit 28 integrates information throughout the account lifecycle by generating control reports 32. Any required information that is missing is gathered from the patient/payor 36 or the healthcare provider 38. As an example, payors often require patients to sign a form acknowledging that the patient has no other insurance carrier. If this form is not present with the claim, the payors will reject it. The manager must contact the patient and arrange to have the form signed by the patient. Note that the manager function 34 is not accounted for in the typical healthcare provider system since the data entry staff have neither the time nor the training to follow-up in this manner. Existing contractual aging software systems 138 cannot possibly account for every payor's requirements. Another example is when medical records must be sent with the bill. If the physician has forgotten to sign the chart, the claim will be rejected. Again, the manager 34 must contact the healthcare provider to obtain the physician's signature prior to the billing phase 26 of the patient account lifecycle. Note further that in the patient contact phase 24, if the required information can be obtained from the patient, the centralized manager 34 will send a checklist alert 40 to the data entry staff member to obtain the information from the patient and complete the edit. During the billing phase 26, however, the centralized manager can obtain the missing information from the patient/payor 36 or healthcare provider 38, as described above, and complete the edit without having to send a checklist alert.

The centralized management unit 28 may have oversight only for a portion of the patient account lifecycle, such as the billing phase 26. In this case, the healthcare provider transfers a portion of the patient accounts 138 to the centralized management unit 28. Writing the patient accounts to an Excel spreadsheet and transferring the resulting file to the centralized management unit's database management system 150 via the Internet 142 can accomplish this. The manager 34 implements the centralized management unit 28 function using only the flashpoints 30 from the billing phase 26. The manager can then access the healthcare provider's patient account system 138 via the Internet VPN 140, 142, 144, update the accounts, and communicate with the healthcare staff members. In this way, the healthcare provider's patient account system can be updated without having to maintain dual accounting systems at both sites. The healthcare provider can then access the control reports, alerts, edits, and checklists, and operating reports via the Internet VPN 140, 142, 144 through the centralized management unit's database management system 150 either directly or using a web-based application 154 from the healthcare provider workstation 139.

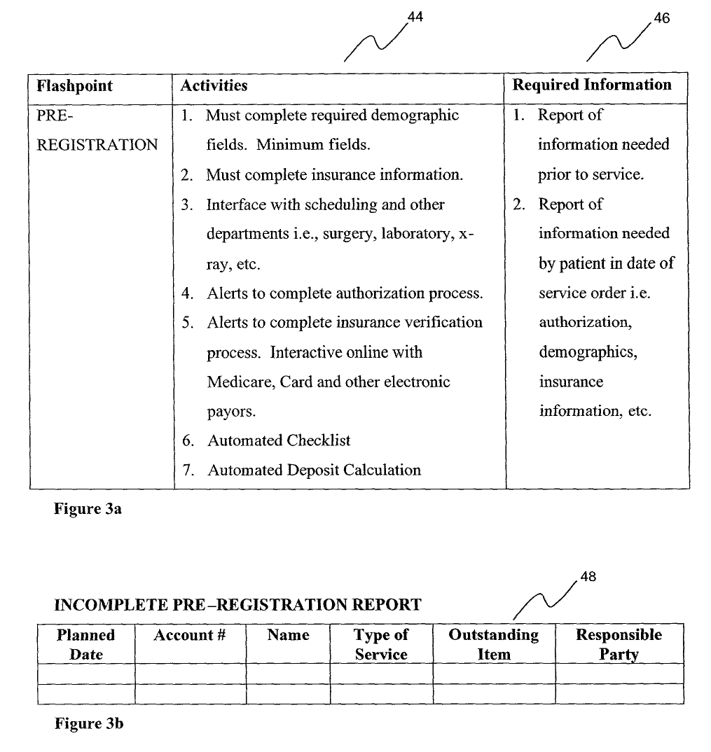

FIGS. 3 through 9 depict some of the key information that is available or required at each flashpoint. Note that although the flashpoints 30 in the patient contact phase 24 and the billing phase 26 are described sequentially, the centralized manager 34 has access to all flashpoints simultaneously. Each day the centralized manager 34 reviews every flashpoint and schedules activity for the next day after prioritizing as described further below.

In FIG. 3a, a list of activities 44 that are part of the checklist for the Pre-Registration flashpoint 10, as well as the information required 46 for the flashpoint, are summarized. The Pre-Registration flashpoint 10 is the first contact with the patient. Manager Integration 34 monitors the flashpoint and extracts information needed for the Incomplete Pre-Registration Report of FIG. 3b. The Outstanding Item 48 column is the most important result of this report. Outstanding items are information required by payors before a claim will be paid that is missing from the edits. Often, the patient account software will not alert the data entry staff member for certain edits since the software cannot know all possible requirements for all payors. This is where the centralized manager 34 must review the requirements for each payor and compare them with the billing edits collected at the flashpoint 10 and passed to the centralized management unit 28, as generally depicted by the flashpoints 30 at the top of FIG. 2. The Incomplete Pre-Registration Report is used to prepare the checklist 40 with required edits and alerts for subsequent flashpoints. This information is available to the healthcare data entry staff member through the patient account software system 138 at any flashpoint 30 and is viewed through the healthcare provider workstation 139. This initial screening in the first flashpoint will significantly reduce or eliminate errors and delays at subsequent flashpoints. A common task is to verify insurance coverage and level of benefits for the particular service requested by the patient.

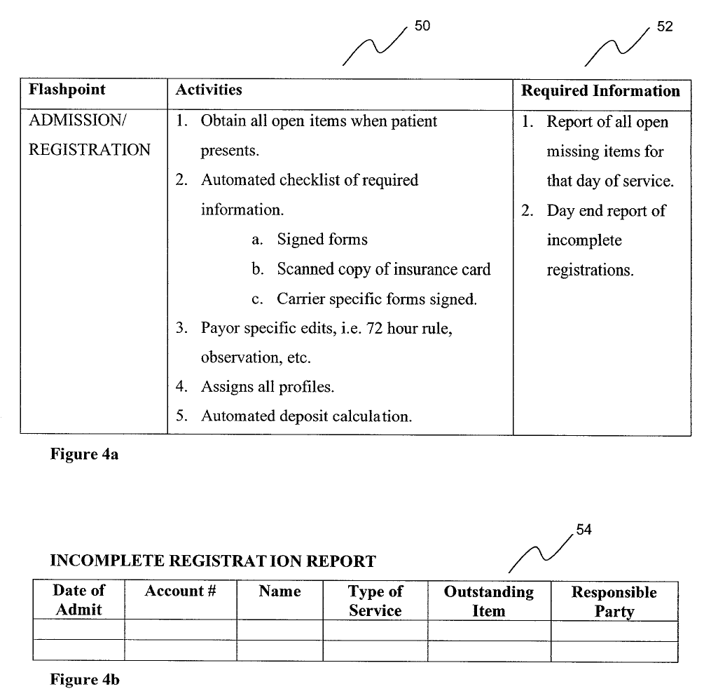

The second flashpoint occurs at the Registration/Admission 12. In FIG. 4a, a list of activities 50 that are part of the checklist for the Registration/Admission flashpoint 12 as well as the information required 52 for the flashpoint are summarized. Once again an automated checklist 40 of all required information is generated to manage this flashpoint proactively. Additionally, any payor specific edits 40 added by the centralized manager 34 to ensure that the payor requirements are satisfied. This is a key flashpoint since payor delays are reduced or eliminated at this stage by completing these payor specific edits. Once again, the centralized manager 34 generates a control report 32 from the flashpoint information 30. The Incomplete Registration Control Report is summarized in FIG. 4b. Again the Outstanding Items column 54 is the key management data to be forwarded to subsequent flashpoints. If any payor specific edits were not identified previously, the centralized manager 34 would add them to the checklist 40 here. If necessary, the centralized manager contacts the healthcare provider 38 or the patient/payor 36 to obtain any missing information. This may be the last time to contact the patient directly depending on the type of service. The checklist 40 is passed on to the flashpoints 30 through the patient account software system 138 or 154 and viewed by the data entry personnel through the healthcare provider workstation 139.

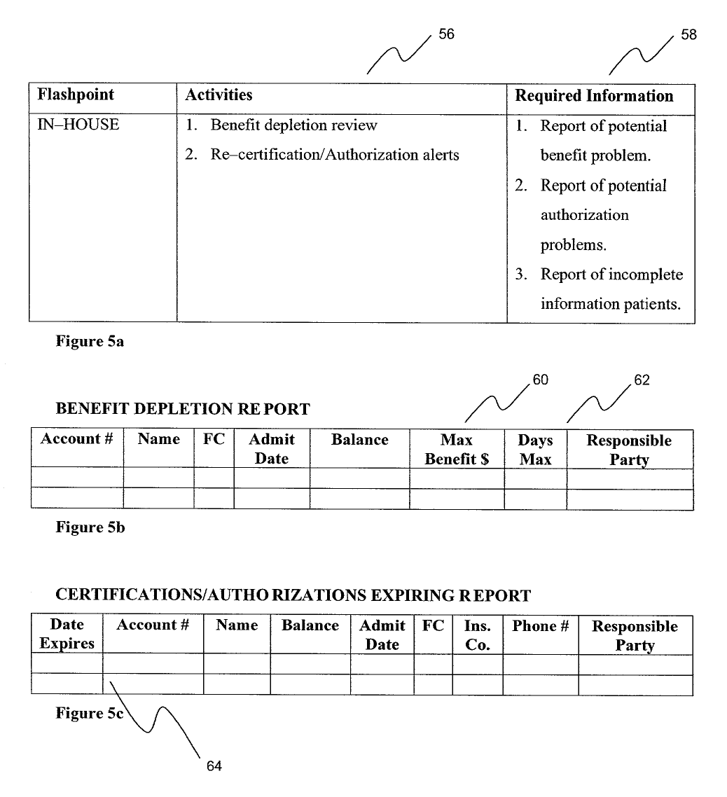

The In-House flashpoint 14 focuses on the patient time in the healthcare facility and is detailed in FIG. 5a. The centralized manager 34 iteratively reviews the control reports 32 at this stage since the management actions required change with time. The key activities 56 are to review benefit depletion and generate alerts when re-certification or re-authorization are required. The information required by the healthcare data entry staff during this flashpoint 58 includes these alerts as well as alerts for missing information from previous flashpoints. As payors often provide different benefits, a key control report is the Benefit Depletion Report shown in FIG. 5b. The columns labeled Maximum Benefit $60 and Maximum Days 62 are the key benefit measures that are limited by the payors. Automatic alerts for re-certification and authorization to extend the benefits are summarized in the Certifications/Authorizations Expiring Report of FIG. 5c. The expiration date 64 is 30 used to sort and prioritize the alerts. These control reports are generated in advance of the benefit depletion dates 64 to trigger proactive management intervention in the patient account lifecycle and ensure that healthcare services will be covered by the payors. Data from these reports are gathered by the centralized manager 34 into a checklist of edits and alerts 40 and merged with the alerts for missing data from the previous flashpoints. Each day the data entry staff member monitors accounts looking for benefit depletion alerts. If an alert is encountered, the staff member contacts the payor for re-certification and authorization to extend benefits. It is also possible that the centralized manager would contact the payor 36 or the healthcare provider 38 for this information.

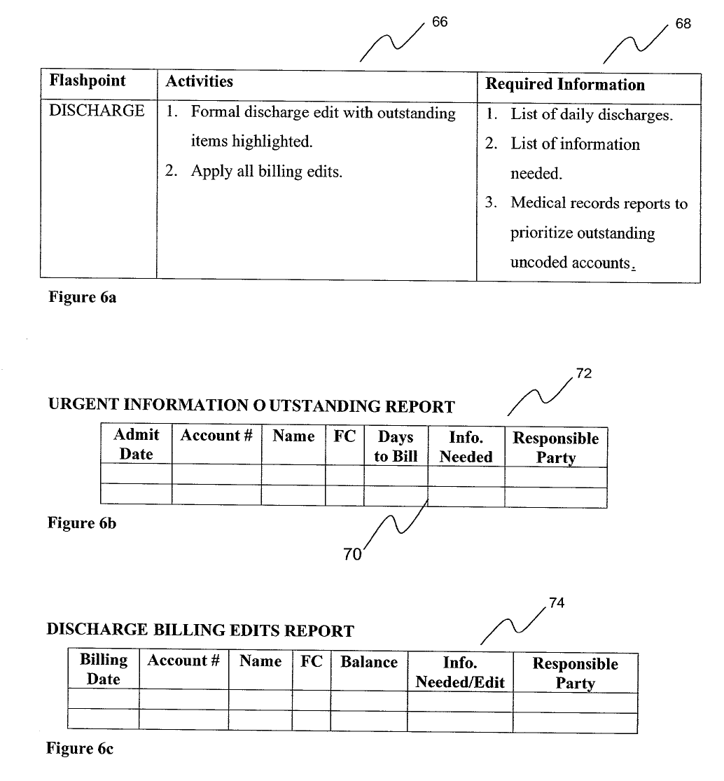

The Discharge flashpoint 16 occurs at patient discharge and is critical because it is the last chance to work with the patient in person to ensure that the patient account is up-to-date and ready for adjudication. This is the last flashpoint in the patient contact phase 24 and the patient is released from the healthcare facility following this flashpoint. FIG. 6a summarizes the Discharge flashpoint 16 activities 66 and required information 68. The most recent checklist 40 highlights all outstanding items and ensures that all remaining billing edits will be properly applied. The Urgent Information Outstanding Report is shown in FIG. 6a and includes the Days to Bill 70 and Information Needed 72. The Days to Bill 70 are used to prioritize the alerts for the checklist 40 and are either determined by the payor or set by a standard. For example, the centralized management unit 28 includes a set of standards as part of the performance measures (described below) for days to bill, i.e., the desired number of days between when the patient is discharged and when the claim should be filed with the payor. Accounts with shorter Days to Bill 70 should receive higher priority since meeting the standard will improve the performance measure for the centralized management unit 28. The Discharge Billing Edits Report is shown in FIG. 6c and includes additional Information Needed 74. The centralized manager 34 generates these control reports from the flashpoint data 30. Note that the discharge date is tied to the required billing date in these control reports. The law specifies a maximum number of days between discharge and filing a claim with a payor. After the maximum number of days, the payor is not required to pay the claim. This is critical information that must be collected and prioritized into a checklist 40 and sent to the subsequent flashpoints, in particular, the Suspense flashpoint 18. The data entry staff member views the alerts as notes in the patient account software 138, 154. This marks the end of the Patient Contact Phase 24.

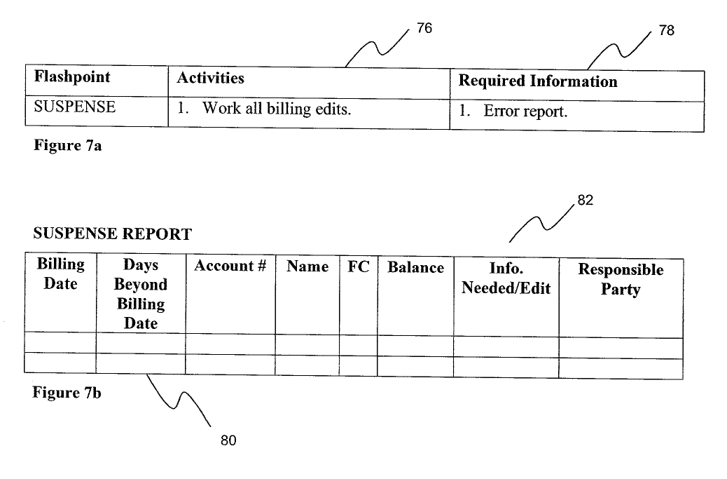

The Billing Phase 26 begins with the Suspense flashpoint 18. The suspense period occurs between the time the patient is discharged and the minimum billing point. FIG. 7a summarizes the activities 76 and required information 78 for the Suspense flashpoint 18. During this time, all remaining billing edits are worked based upon the checklist 40 generated by the central management unit 28. The centralized manager 34 prepares the checklist by reviewing the control reports 32 generated by the data from the previous flashpoints 30. The Urgent Information Outstanding Report from FIG. 6b and the Suspense Report in FIG. 7b contain the critical information required by the centralized manager to sort, prioritize, and work the accounts. The Days to Bill 70 and Information Needed 72 are used to prioritize the accounts and form the alerts for the checklist. The Days Beyond Billing Date 80 and Information Needed/Edit 82 are used to track and control accounts that do not meet the minimal/optimal time to bill criteria. These accounts are in danger of being rejected by the payor for non-compliance with the law and receive highest priority. The checklist 40 is available to the flashpoints 30 through the patient account software 138, 154. It is highly likely that the centralized manager will have to contact the healthcare provider 38 or the patient/payor 36 during the billing phase 26 since the patient is no longer in the healthcare facility and the account may be several weeks old.

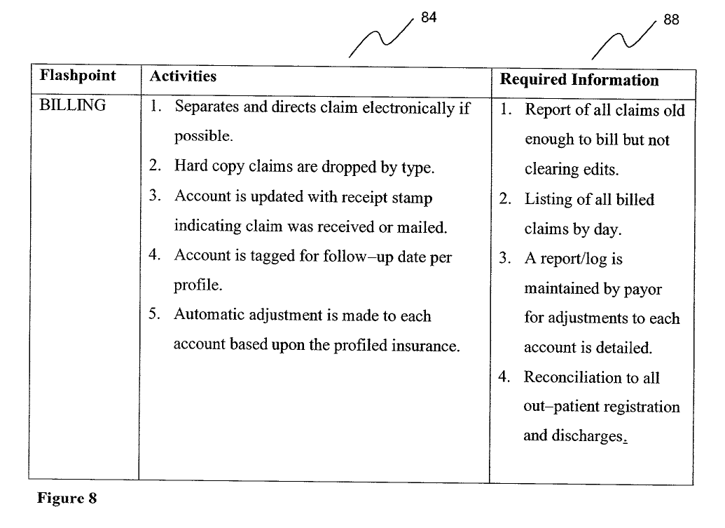

The Billing flashpoint 20 activities and required information are summarized in FIG. 8. Patient accounts are separated depending on whether they can be billed electronically by the healthcare provider's data entry staff members. Electronic billing is more accurate and ensures that the payor receives the billing information since an electronic acknowledgment is required. Accounts are updated as they are billed. The centralized manager 34 generates the checklist for this flashpoint using the Suspense Report of FIG. 7b. Again, the Days Beyond Billing Date 80 and the Information Needed/Edit 82 are used to prioritize the accounts and to generate the alerts 40. This flashpoint is the last chance for management intervention to prepare a patient account for billing with the appropriate payor edits to ensure prompt and accurate adjudication of the account. The checklist 40 is available to the flashpoints 30 through the patient account software 138, 154. It is highly likely that the centralized manager will have to contact the healthcare provider 38 or the patient/payor 36 during this flashpoint since the patient is no longer in the healthcare facility and the account may be several weeks old.

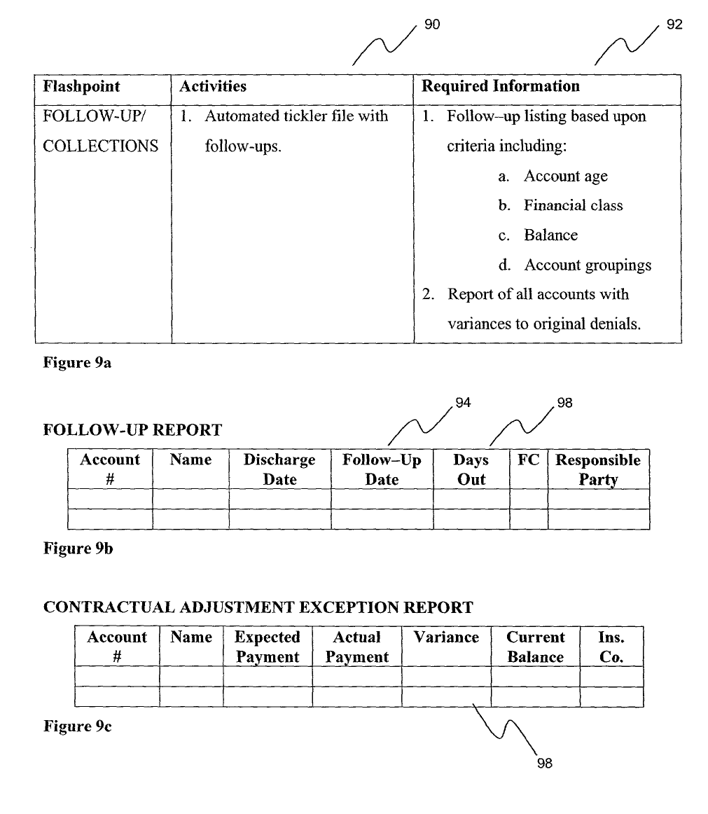

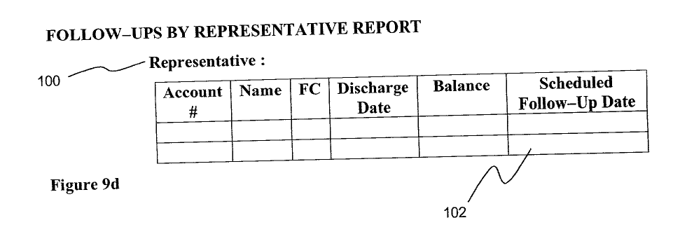

The Follow-Up/Collection flashpoint 22 is the seventh and final flashpoint. The activities 90 and required information 92 for this flashpoint are summarized in FIG. 9a. The centralized manager 34 uses the flashpoint data 30 to generate a Follow-Up Report as in FIG. 9b, a Contractual Exception Report as in FIG. 9c, and a Follow-Up by Representative Report as in FIG. 9d. The healthcare facility rarely has personnel involved in follow-up or are understaffed so the focus of this flashpoint for the centralized manager 34 is the Follow-Up by Representative Report. The Days Out column 98 is used to prioritize the follow-up work. The Follow-Up Date 94 from the Follow-Up Report (FIG. 9d) is transferred to the Follow-Up Date 102 in the Follow-Up by Representative Report (FIG. 9d). Accounts are assigned by the centralized manager 34 to account representatives from the centralized management unit 28. This flashpoint can continue indefinitely since the payor must constantly be monitored and interrogated to ensure that patient accounts are adjudicated in a timely and accurate fashion.

The centralized manager 34 provides business office services remotely through the centralized management unit 28. The centralized manager 34 establishes a VPN tunnel 140, 142, 144 with the healthcare provider over the public Internet and accesses the healthcare provider's existing patient account software as depicted in FIG. 13. The VPN tunnel is established using encryption and authentication devices 140, 144 that automatically negotiate the connection, exchange encryption keys, and establish the tunnel whenever a centralized manager 34 attempts to connect to the healthcare service provider's patient account system 138 using the terminal emulation software 148. The encryption and authentication devices 140, 144 also negotiate digital certificates for authentication to ensure that only those users with appropriate authorization who can prove their identity through a third-party (such as Verisign) are allowed access to the healthcare provider's existing network and data 138. Encryption over the VPN tunnel and authentication using digital certificates is key to this embodiment to ensure patient privacy and to protect the healthcare provider's network and data 138. Authentication also occurs automatically. Once the VPN tunnel is established, the centralized manager 34 is presented with a login prompt through the terminal emulation software 148.

Similarly, the healthcare provider can use the web-based approach in FIG. 14. Data entry operators at the healthcare provider workstations 139 access the patient account application server 154 via a web browser. Patient account data are entered into the database management system 150. In this approach, the encryption and authentication is provided by a secure sockets layer transaction. When first accessing the application server 154, the data entry operator at the healthcare provider workstation 139 is presented with a digital certificate for the centralized management unit 28 (FIG. 1). If accepted, the secure sockets layer transaction establishes an encrypted session between the healthcare providers web browser and the application server 154. The centralized manager 34 (FIG. 2) at the service provider workstation 148 also accesses the application server 154 and can perform the management function as described above. The healthcare provider also has access to all of the control reports and operating reports via the web browser.

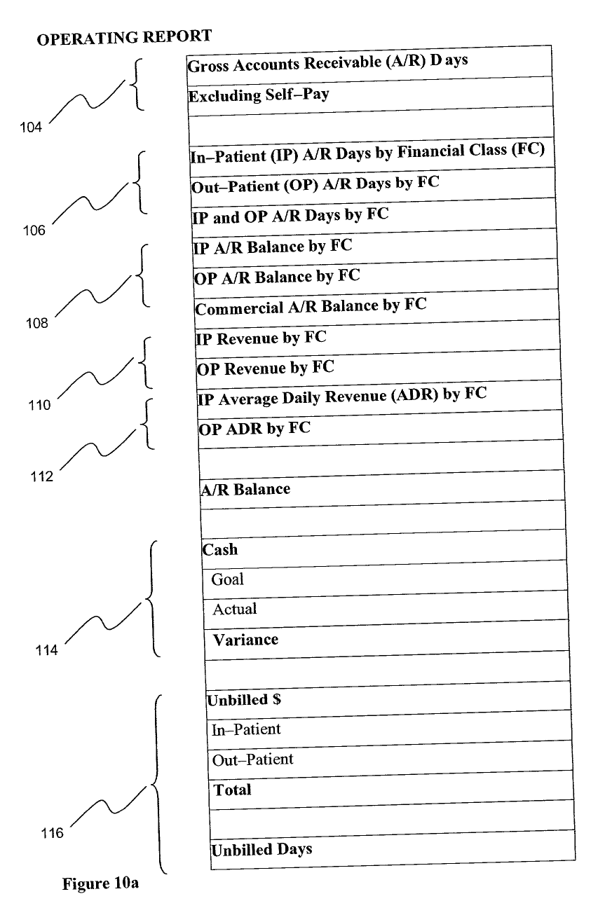

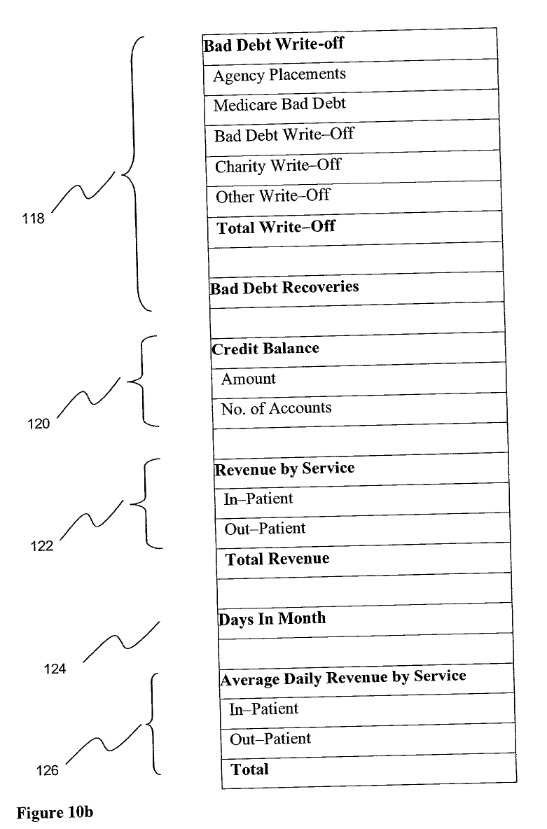

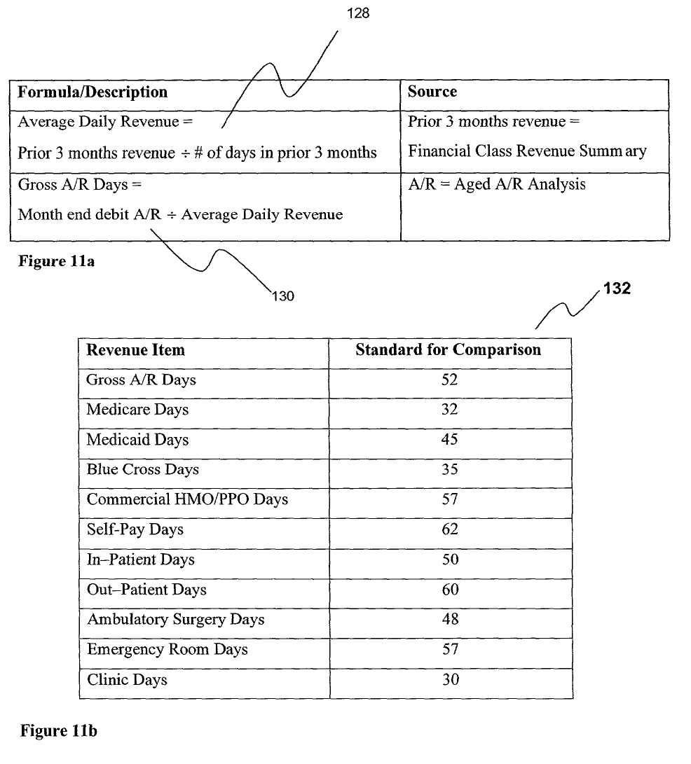

Periodic operating reports such as the example shown in FIGS. 10a and 10b are used to quantify the performance of the patient account management system and to provide feedback whereby the system can be continuously improved and ensure maximum revenues, improved cash flow, bad debt reduction, reduced costs, and reduced healthcare days in receivable. The report is divided into several sections. The first section is the Gross A/R Days and Gross A/R Days Excluding Self-Payors 104. These days are used later as normalization factors. Next are the In-Patient and Out-Patient A/R Days 106. These are broken down by Financial Class (Medicare, Medicaid, Blue Cross, etc.). The In-Patient and Out-Patient A/R Balance as well as Commercial Insurers A/R Balances 108 are also broken down by financial class. Finally, In-Patient and Out-Patient Revenue 110 and In-Patient and Out-Patient Average Daily Revenue 112 are broken down by financial class.

Average Daily Revenue Computation 128 and Gross A/R Days Computation 130 are summarized in FIG. 11a. These are the primary performance measures for the centralized management unit 28. Average Daily Revenue 112 should increase over time and Gross A/R Days 104, 106 should decrease over time in a successful patient account lifecycle management system. A standard days for comparison 132 is summarized in FIG. 11b. These standards are used to determine the financial classes or types of service that are causing problems. The centralized manager 34 uses this information to determine where management intervention in the patient account lifecycle is required. These reports provide direct insight into the patient account lifecycle and allow the centralized manager 34 to monitor, direct, and train the healthcare service provider's staff and ensure that problem areas are corrected quickly and avoid bad debt write-offs.

The operating report also measures the cash variance from the goal 114. Information about unbilled accounts is also collected 116. Both of these measures should decrease over time as the patient account lifecycle becomes more efficient and maximum revenues are collected for services billed. The centralized manager 34 notes problems with unbilled accounts 116 and reviews the Follow-Up Reports in FIG. 9 to determine whether an account representative is having difficulty.

Bad-Debt Write-Offs and Recoveries 118 are computed in the operating report and used by the centralized manager 34 to discover problem financial classes. These can often be traced to a particular healthcare staff member or account representative in the centralized management unit 28 in need of training. It is important to reduce the amount of Bad-Debt Write-Offs as well as Recoveries. These are sent to collection agencies for recovery and are not always successful. Additionally, because the collection agency fees are very high, the healthcare services provider will only recover a limited portion of the total bill.

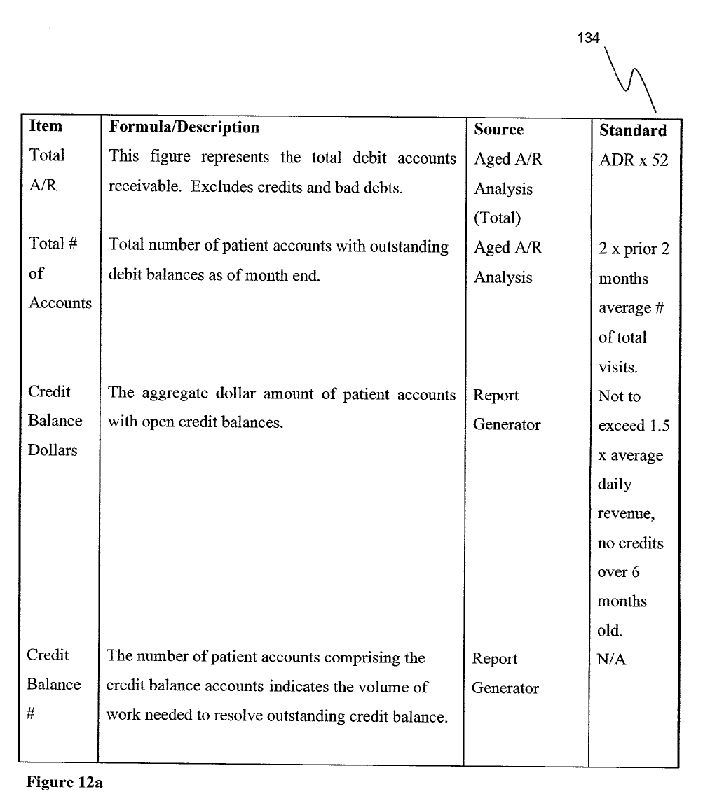

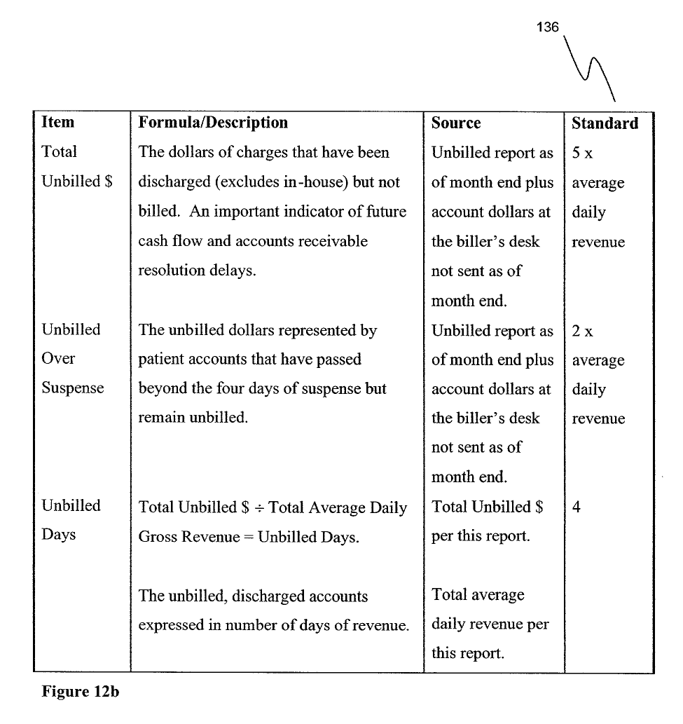

The Average Daily Revenue by Service 126 is computed using the Credit Balance 120, Revenue by Service 122, and Days in Month 124. This is a summary computation that reflects In-Patient versus Out-Patient average daily revenue. These should increase over time as the centralized management unit improves the patient account lifecycle process. FIGS. 12a and 12b define these performance measures, provide a source for the information, and most importantly, provide a standard for comparison 134, 136. The centralized manager 34 periodically reviews all of the information in the operating report, determines problem areas by financial class or service, and takes action to correct the patient account lifecycle process.

Accordingly, the reader will see that the system and apparatus of this invention can be used to manage the entire patient account lifecycle either on-site or remotely using the healthcare provider's existing patient account system. Furthermore, the patient account lifecycle management system has the additional advantages in that:

a) it permits the services provider the ability to remotely manage patient accounts using the existing healthcare provider's patient account system and without maintaining duplicate patient account systems;

b) it provides a cost-effective means for healthcare providers to out-source any portion of the patient accounts by allowing the services provider to use the Internet rather than the telephone network;

c) it provides for the privacy of the patient using an encrypted VPN tunnel;

d) it provides for the security of the healthcare provider's data and network using encryption and digital certificates for user authentication;

e) it provides a comprehensive set of management control reports and operating reports so that the patient account lifecycle process can be continuously improved and so that revenues will be maximized by improving cash flow, reducing bad debt, reducing costs, and reducing healthcare days in receivable.

Although the description above contains many specifications, these should not be construed as limiting the scope of the invention but as merely providing illustrations of some of the presently preferred embodiments of this invention. For example, the system can provide security using a secure shell approach or other VPN implementation; the system can use a dial-up connection rather than the public Internet; etc.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A method for managing a healthcare patient account lifecycle comprising the steps of:
identifying a plurality of flashpoints corresponding to defined operations in the patient account lifecycle;
providing an output at said plurality of flashpoints, said outputs comprising a control report; and
converting at least one control report from a first flashpoint into an input for a subsequent flashpoint, the input for a subsequent flashpoint including at least one of a checklist, an alert, and an edit relating to information required for obtaining payment from a healthcare payor.

2. The method of claim 1 wherein said flashpoints include patient contact events comprising a pre-registration phase, an admission/registration phase, an in-house phase, and a discharge phase.

3. The method of claim 1 wherein said flashpoints include post-discharge events comprising a suspense phase, a billing phase, and a follow-up/collections phase.

4. The method of claim 1 wherein data from each flashpoint is output to a centralized management unit, said centralized management unit adding missing data in the form of an edit, or returning a checklist to the flashpoint operator with alerts to obtain said missing data.

5. The method of claim 4 further comprising a centralized manager who generates control reports, said control reports being used to highlight missing data required for obtaining payment from a payor, and who obtains said missing data from a source outside the centralized management unit.

6. The method of claim 5 wherein said source outside the centralized management unit comprises at least one of healthcare provider, patient, or payor.

7. The method of claim 4 comprising a communications network between the centralized management unit and a healthcare provider, and a plurality of encryption devices located in said communications network, said encryption devices establishing an encrypted session over the communications network and including a means for authenticating remote managers in the central management unit whereby the central management unit can manage patient lifecycle accounts.

8. The method of claim 7 wherein said communications network comprises the Internet.

9. The method of claim 7 wherein said encryption device comprises a firewall VPN router.

10. The method of claim 7 wherein digital certificates are used to authenticate managers in the centralized management unit.

11. The method of claim 4 comprising an encrypted communications network between the centralized management unit and the healthcare provider, a web browser, a database management system, and a software application, and including the step of using said software application via the web browser over the encrypted communications network to store patient account data in the database management system whereby a healthcare provider can outsource any portion or all of its patient accounts for management by the centralized management unit.

12. The method of claim 11 wherein the encrypted communications network comprises a secure sockets layer, the Internet, and digital certificates for authentication.

13. The method in claim 4 further comprising outputting operating reports from the centralized management unit detailing the performance of the method for managing a patient account lifecycle and providing information for analysis of the performance of the method whereby improvements can be traced to particular flashpoints and operators requiring additional training or support.

14. The method of claim 13 further comprising pre-determined standards for comparison to determine the level of performance of the centralized management unit.

15. The method of claim 14 wherein said standards comprise Gross Accounts Receivable Days by Financial Class, Accounts Receivable Balance by Financial Class, Average Daily Revenue by Financial Class, Cash Variance, Unbilled Accounts Balance, Unbilled Days, Bad-Debt Write-Off Balance, Bad-Debt Recoveries, Credit Balance, and Average Daily Revenue by Service.

16. The method of claim 7 further comprising a database management system in the centralized management unit wherein the healthcare provider transfers a portion of post-discharge patient accounts for management by the centralized management unit, said centralized management unit using the communications network to update the healthcare provider's patient account system directly whereby the centralized management unit is not required to maintain and coordinate a duplicate set of patient accounts.

17. A system for managing a healthcare patient account lifecycle comprising a healthcare provider, a centralized management unit, a communications network between the healthcare provider and the centralized management unit, the communications network including a plurality of encryption devices establishing an encrypted session over the communications network and including a means for authenticating remote account managers in the centralized management unit, and said centralized management unit accessing patient account information from the healthcare provider and providing information to the healthcare provider for managing information retrieval required for billing a healthcare payor.

18. The system of claim 17 wherein the centralized management unit generates and transmits to the healthcare provider information relating to at least one of a checklist, an alert, and an edit relating to information required for payment from a healthcare payor.

19. The system of claim 17 further including a web browser, a database management system, and a software application, the database management system storing patient account data received from the healthcare provider by the centralized management unit whereby a healthcare provider can outsource any portion or all of its patient accounts for management by the centralized management unit.

20. The method of claim 17 wherein said communications network comprises the Internet.

21. The method of claim 17 wherein said encryption device comprises a firewall VPN router.

22. The method of claim 17 wherein digital certificates are used to authenticate managers in the centralized management unit.
